(19) United States
(12) Patent Application Publication
(10) Pub. No.: US 2009/0271972 A1
(43) Pub. Date: Nov. 5, 2009

(54) Method for Producing a Contactless Transponder by Stitching a Contactless Module to an Antenna, and Transponder Obtained

(75) Inventors: Jean-Paul Caruana, Marseille (FR); Frédérick Seban, Cassis (FR)

Correspondence Address: BUCHANAN, INGERSOLL & ROONEY PC, POST OFFICE BOX 1404, ALEXANDRIA, VA, 22313-1404, US

(73) Assignee: Gemplus, Gemenos (FR)

(21) Appl. No.: 12/085,217

(22) PCT Filed: Nov. 20, 2006
(86) PCT No.: PCT/EP2006/068681

§ 371 Date: Apr. 15, 2009

(30) Foreign Application Priority Data
Nov. 21, 2005 (FR) 0553526

(51) Int. Cl. H01P 11/00

(52) U.S. Cl. 29/600

(57) ABSTRACT

A contactless transponder includes an antenna and an electronic module placed on a substrate and connected to the antenna by a conducting wire passing through the contact pads in the form of at least one stitch. The module is produced as a single block, having at least one integrated circuit and contact pads. The module is transferred to the substrate before connection to the antenna.

The invention relates to a method for producing a contactless transponder comprising an antenna and an electronic module placed on a substrate, said module including contact pads connected to the antenna.

The invention, more particularly, relates to a method for connecting a radio-electric antenna to a contactless electronic module having radio-frequency communication functions.

The invention aims at using the hereabove-mentioned method for producing a contactless chip card and/or a travelling document such as an electronic passport, an electronic visa, an electronic label, any communication electronic product including the connection of a module to an antenna.

Among the methods for producing high quality transponders having extremely reproducible and performing characteristics, the utilisation of a wire antenna positioned in a plastic card body by means of the technology using a wire embedded with ultrasound probes is known. The module is then connected by thermal compression using the same antenna wire.

Such conducting wires, generally made of copper, are very thin, less than 300 μm and spaced of the order of a few hundreds of μm to constitute the turns of an antenna, and they make it possible to obtain a high quality factor, for example above 40, contrary to the antennae obtained by depositing a conductive material, more particularly by screen-printing with a conductive ink.

Such embedding method appears to be relatively slow. Besides, it appears necessary to change tools for the connection of the wire to the contact pads of an electronic module.

On the other hand, it is necessary to have conductive wires sheathed with some insulating material to carry out the crossing of turns without causing a short circuit.

The document JP 2001-344580 is also known, which describes a method for producing an antenna by stitching a conductive wire which extends on a plane of the substrate and alternately, on the opposite plane thereof.

The antenna is directly connected to the lands of an integrated circuit chip, by means of some conductive material.

This connection method is most probably implemented manually, and it appears not very efficient as regards the connection of the chip and not to allow an industrialisation.

The invention aims at enabling a durable connection of a contactless module to an antenna with a good mechanical fastening of the module on a substrate and an industrialisation of such connection.

The invention also aims at producing the antenna and a crossing of turns forming the antenna without a short circuit, with a minimum of steps.

For this purpose, the object of the consists of a method for producing a contactless transponder comprising an antenna and an electronic module placed on a substrate and connected to the antenna by a conducting wire, passing through the contact pads in the form of at least one stitch;

The method is characterised in that it includes the following steps:
production of a module as a single block, said module comprising at least one integrated circuit having connection lands and contact pads connected to the lands,
transfer of the module to the substrate prior to the connection to the antenna.

Thus, the module may be connected and/or mechanically fastened on the substrate in an industrial and quick way, in fewer operations.

In addition, the module may be produced, in practice, using the technology of the chip card, and electrically tested, prior to being transferred.

According to other characteristics of the method:
the antenna is also placed on the substrate with a stitch;
a contact pad is connected first, then the antenna is produced and the second contact pad is connected, by means of a continuous stitching in a single operation, using the same needle;
the method comprises a step of crossing the turns of the antenna SP1 by means of a conductive wire passing above portions of the antenna in the form of a loop embedded in the substrate;
at least one perforation is made on the contact pads prior to the connection.

Another object of the invention also consists of a contactless transponder including an antenna and an electronic module placed on a substrate and connected to the antenna by a conducting wire passing through the contact pad in the form of at least one stitch.

It is characterised in that the module comprises at least one integrated circuit and contact pads, in the form of a single block on the substrate.

Other characteristics and advantages of the invention will appear upon reading the following description which is given as an illustrative and non-limitative example, and while referring to the appended Figures in which:

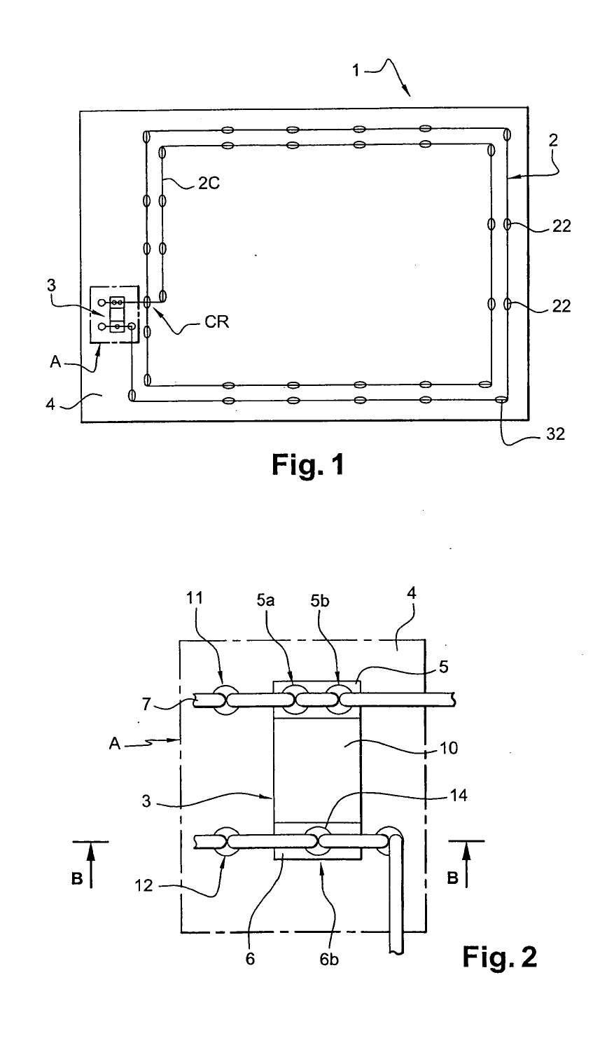

FIG. 1 illustrates a schematic view of a transponder according to a preferred embodiment of the method of the invention;

FIG. 2 illustrates in detail the electronic circuit module of FIG. 1 with the connections thereof;

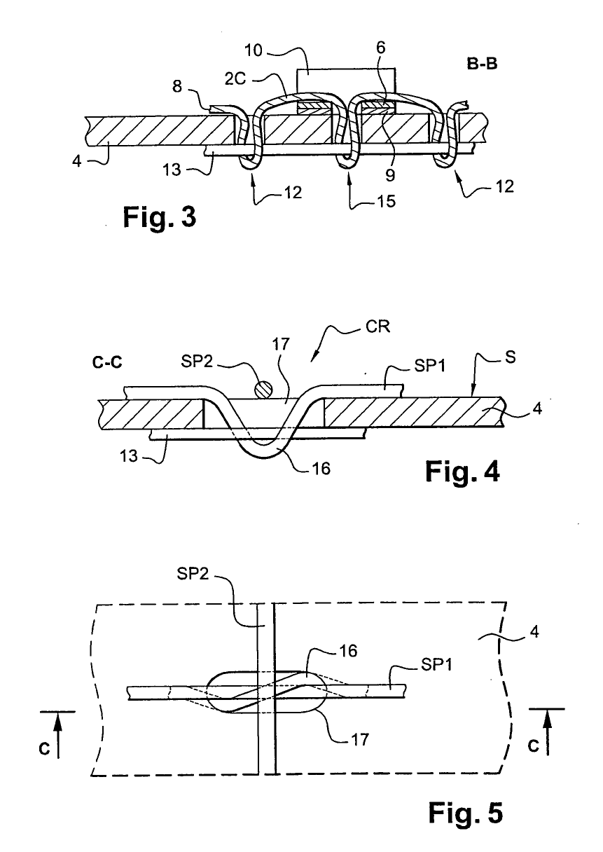

FIG. 3 illustrates a cross-sectional view of FIG. 2 along B-B;

FIG. 4 illustrates an exemplary crossing CR of conducting wires as shown in FIG. 1;

FIG. 5 is a top view of FIG. 4.

As shown in FIGS. 1 and 2, a contactless transponder 1 includes an antenna 2 and an electronic module 3 placed on a substrate 4. The module includes, on a support, contact pads 5, 6 connected to the antenna. The antenna is produced on the substrate 2 using a conducting wire including two ends 7, 8.

The module in the example is an electronic module of the contactless type including a support 9 of the integrated circuit type, provided with an integrated circuit chip 10 fastened to the support and connected by a welded wire, or according to a technique of the flip-chip type (the chip is turned upside down and connected with a conducting glue), to the contact pads 5, 6 extending on either side of the support.

The module may be produced without any dielectric support and the pads may be directly in contact with the substrate.

A coating with a protective resin may cover the chip and its contacts.

According to one characteristic of the invention, a conducting wire passes through the contact pads and connects them. In the example, the connection is carried out substantially near and upstream from the ends 7, 8 of the antenna. Just upstream from such ends, the wire is fastened on the substrate after the electric connection and forms a bonding point 11, 12 on the substrate.

A contact pad 5 includes two connection points 5a, 5b, whereas the contact pad 6 includes one connection 6a. Several stitches, for example three, four passing through the pads make it possible to improve the connection if the space allows it.

In the example, the conducting wire is the wire constituting each turn of the coil 2. As a matter of fact, the wire forming the turns and connecting the pads is continuous from one contact pad to the other.

The antenna includes stitches 22 distributed along the turns and more particularly, in the angles and changes of direction 32.

A preferred embodiment of the method for producing the transponder of FIG. 1 will now be described.

An insulating substrate 4 is provided, which may be, for example, a film or a sheet of a polymer material, PVC, PET (polyethylene), polycarbonate, paper, material for an integrated circuit or a chip card module such as, more particularly, polyimide in a strip or in a roll, or any other material currently used for producing transponders.

The substrate may have various thicknesses, generally lower than or equal to that of a chip card (0.76 mm), so as to serve as an insert between two films or sheets, or to serve as a support for a coating and/or a printing sheet, if need be. Typically, the substrate may be 0.1 mm in thickness.

The module is placed on this substrate, for example, using some glue. An adhesive is not indispensable if the module is transferred and placed on the substrate at a module connection station, using stitches. At this station, a transfer tool can hold the module in place while it is connected.

The method may then include the following steps which consist in forming the antenna on the substrate, said antenna including two end parts 7, 8 for the connection, then for the connection of said end parts of the antenna to the contact pads using a conducting wire.

According to a characteristic step of the method, the contact pads are stitched with at least one stitch (5a, 5b, 6b) passing through the contact pads using a conducting wire.

The stitch defines a loop 12 and includes an insulating shuttle wire 13 which passes through the loop to hold the conducting wire against the substrate.

The loop and/or the shuttle wire may be more or less deeply embedded in the substrate according to the tension of their respective wire and to the adjustment of a stitching machine used in the method.

In an alternative embodiment, the antenna may be produced in different ways, more particularly by etching, ultrasound deposition, with the ends of the antenna being placed close to the module and then connected according to the method of the invention.

In this case, the stitches also stitch the ends or the neighbourhood thereof, for the connection thereof.

However, according to an advantageous provision of the method, the antenna is also placed in the substrate using stitches including an upper wire and an insulating shuttle wire.

In a preferred embodiment, the method may be as follows: first, a contact pad 5 is connected by stitching, more particularly with a starting point 7, which is previously made on the substrate, then the antenna 2 is produced by a continued stitching and then the second contact pad 6 is also connected by stitching.

The whole production is thus made by stitching in one single operation and using the same sewing machine needle.

In FIG. 2, the contact pads include at least one perforation 14. Several perforations are recommended to make it possible to better connect electrically the module and to fasten it mechanically to the substrate.

Preferably, the perforations or holes 14, provided in the contact pads, may be carried out previously, more particularly by punching, so as to more particularly reduce the wearing of the needle of a sewing machine.

A location marking system for the module and the previous perforations of the CAV (computer aided vision) type is preferably provided at a station for connecting the antenna to the module, in order to check the positioning, the moving and the pricking of the needle.

The fastening of the module, in this case, is very similar to the automatic fastening of a button on a shirt in particular.

If need be, it is possible to make several stitches in both perforations 5a, 5b using a thinner conducting wire or a wider perforation. The stitch 11 is not indispensable since the wire may be cut at stitch 5a.

In FIG. 3, the conducting wire of the antenna 2 or the connection wire 2C includes loops 15 which pass through the pads and the substrate. These loops are held by a lower wire 13 or insulating shuttle wire.

FIGS. 4 and 5 illustrate a crossing CR of conducting wires. The invention allows the return of the inner turn 2C of the conductive coil 2 to the contactless chip to be connected thereto (FIG. 1).

According to a first embodiment, FIG. 4, the conducting wire SP1 is embedded in the form of a loop 16 in the substrate, in a relatively wide perforation 17 so as to push away the portions of the wire, which are going up on either side of the perforation. Between these two portions, a conducting wire SP2 may extend to cross the loop without causing a short circuit therewith. The margin available between the crossed wires is, for example, equal to one to three times the diameter of the conducting wire. Conducting wires made of copper for example, may have a diameter between 0.03 mm and 1 mm.

In another embodiment, not shown, the isolating wire would be pushed up into the hole 17 by a greater tension of the conducting wire SP1 until it is in contact with the crossing upper conducting wire SP2. The insulating wire 13 then constitutes a bridge or an insulating rest for the crossing conducting wire, which can thus cross the turn of the antenna SP1 placed under the insulating wire 13. The insulating wire 13 holds a portion of the turn SP1 at least partially embedded under the upper surface S which carries the antenna.

Any perforation may be previously performed, more particularly by punching or be performed using a needle during the sewing operation. In case plastic is used, a needle deforms the material of the substrate and produces small curls around the perforation.

An advantage of the invention consists in allowing the utilisation of a bare conducting wire for connecting and/or producing the conducting coil. Therefore, it is possible to use a wire having a very small diameter down to, for instance, 30 μm which is not available as an insulated wire (sheathed in plastic).

Advantageously, the substrate may be provided with many perforations, regularly distributed at least on the path of the antenna turns or on the whole surface as a matrix, a perforated card.

The perforations may be filled by fluxing material during the rolling of thermo-plastic sheets. The method is appropriate for the formation of a contactless insert for any product and more particularly, chip cards.

The invention is applicable to any radio-frequency electronic product, such as a contactless chip card, including the transponder produced according to the method.

1. A method for producing a contactless transponder including an antenna and an electronic module positioned on a substrate and connected to the antenna by a conducting wire passing through the contact pads in the form of at least one stitch, wherein said method includes the following steps:
production of a module as a single block, said module comprising at least one integrated circuit having connection lands and contact pads connected to the lands,
transfer of the module to the substrate before connection to the antenna.

2. A method according to claim 1, wherein the antenna is also placed on the substrate with a stitch.

3. A method according to claim 1, wherein a contact pad is connected first, then the antenna is produced and a second contact pad is connected, by means of a continuous stitching in a single operation, using the same needle.

4. A method according to claim 1, comprising a step of crossing turns of the antenna using a conducting wire passing over portions of the antenna in the form of a loop embedded in the substrate.

5. A method according to claim 1, wherein at least one perforation is made on the contact pads prior to the connection.

6. A contactless transponder including an antenna and an electronic module placed on a substrate and connected to the antenna by a conducting wire passing through the contact pad in the form of at least one stitch, wherein the module comprises at least one integrated circuit and contact pads forming a single block on the substrate.

7. A radio-frequency communication electronic product such as a contactless chip card comprising the transponder according to claim 6.
